(19) United States
(12) Patent Application Publication
(10) Pub. No.: US 2014/0165065 A1
(43) Pub. Date: Jun. 12, 2014

(54) PROCESS REQUESTING APPARATUS, METHOD OF CONTROLLING PROCESS REQUESTING APPARATUS AND RECORDING MEDIUM FOR PROCESS REQUESTING APPARATUS

(71) Applicant: Takehiro KAMATA, Saitama (JP)

(72) Inventor: Takehiro KAMATA, Saitama (JP)

(21) Appl. No.: 14/093,219

(22) Filed: Nov. 29, 2013

(30) Foreign Application Priority Data
Dec. 11, 2012 (JP) 2012-270571

(51) Int. Cl. G06F 9/48

(52) U.S. Cl. CPC G06F 9/4806
USPC 718/100

(57) ABSTRACT

A process-requesting apparatus for requesting a process-performing apparatus to perform a predefined process and querying a progress status of the predefined process includes a progress status obtaining unit for obtaining, as a response to the query about the progress status to the process-performing apparatus, the progress status from the process-performing apparatus; a completion determining unit for determining whether the predefined process has been completed based on the obtained progress status; a time interval determining unit for determining a time interval from the last time the process-requesting apparatus queried the progress status to the next time the process-requesting apparatus queries the progress status according to an elapsed time from the start of the predefined process; and a progress status querying unit for, in the case where the predefined process has not been completed, querying the process-performing apparatus about the progress status at the determined time interval.

### BACKGROUND OF THE INVENTION

1. Field of the Invention

The disclosures herein generally relate to a process requesting apparatus, a method of controlling a process requesting apparatus, a recording medium for the process requesting apparatus, and especially relate to a process request to a server apparatus in the process requesting apparatus.

2. Description of the Related Art

Recently, an online system has already been proposed and known wherein when a process request is transmitted to a server apparatus that provides a predefined function from a client terminal that is implemented by an information processing apparatus such as a PC (Personal Computer), etc., the predefined function is provided by the server apparatus in accordance with the received process request (refer to, for example, Patent Document 1). In this kind of online system, the server apparatus, which has received the process request from the client terminal, is supposed to perform the process in accordance with the received process request, and, when the process is completed, to return a completion report to the transmission source of the process request, in this case the client terminal.

In this kind of online system, if there is no information transmission/reception between the client terminal and the server apparatus for more than a certain period, then it may be assumed to be a timeout, and the communication may be disconnected automatically. Also, in this kind of online system, in addition to the above timeout function, there may be a function in which no information transmission/reception is performed between the client terminal and the server apparatus during the time from when the process request is transmitted to the server apparatus to when the completion report is transmitted to the client terminal. As a result, in this kind of online system, there is a problem that: if it takes more than the certain period from when the process request is transmitted to the server apparatus to when the completion report is transmitted, then it is assumed to be a timeout, the communication is automatically disconnected, and the completion report is not transmitted.

Therefore, in the case where it takes more than the certain period from when the process request is transmitted to the server apparatus to when the process is completed, the server apparatus, when it starts performing the above process, is supposed to report the same to the client terminal so that the timeout function will not be performed. Also, regarding a function of checking the process completion from the client terminal, it is implemented by a checking request which is transmitted from the client terminal to the server apparatus, asking whether the process is completed or not, and by a response from the server apparatus.

However, in this kind of online system, there is a problem that, because the client terminal cannot detect when the server apparatus has completed the process, the timing is not clear when it should transmit the checking request to the server apparatus.

Therefore, an online system has already been proposed and known in which, in order to solve the above problem, a process called “polling” is performed after the transmission of the process request, in which “polling” process, the client terminal queries the server apparatus about whether the process is completed or not at a certain interval. As a result, in this kind of online system with the “polling” process, even if it takes more than a certain period from the transmission of the process request to the server apparatus until the transmission of the completion report, the timeout can be avoided, and also it is not necessary for the client terminal to detect when the server apparatus has completed the process.
[Patent Document 1] Japanese Patent Application Publication No. 2007-234052

### SUMMARY OF THE INVENTION

It is a general object of the present invention, in the case where a client terminal utilizes a certain function provided by a server apparatus, to reduce unnecessary communication traffic without degrading the real-time capabilities and also to reduce the process loads of the client terminal and the server apparatus.

In one embodiment, a process requesting apparatus requests a process performing apparatus that performs a predefined process to perform the predefined process, and queries the process performing apparatus about a progress status of the predefined process. The process requesting apparatus includes a progress status obtaining unit configured to obtain the progress status from the process performing apparatus as a response to the query about the progress status to the process performing apparatus, a completion determining unit configured to determine whether the predefined process is completed or not based on the obtained progress status, a time interval determining unit configured to determine a time interval between the last progress status query and the next progress status query in accordance with an elapsed time from the beginning of the predefined process, and a progress status querying unit configured to, in a case where the predefined process is not completed, query the process performing apparatus about the progress status at the determined time interval.

Another aspect of the present invention is a control method of a process requesting apparatus configured to request the process performing apparatus that performs a predefined process to perform a predefined process and to query the process performing apparatus about a progress status of the predefined process. The method causes the process requesting apparatus to perform: a step of obtaining the progress status from the process performing apparatus as a response to the progress query to the process performing apparatus; a step of determining whether the predefined process has been completed or not based on the obtained progress status; a step of determining a time interval from the last progress status query to the next progress status query in accordance with an elapsed time from the start of the predefined process; and a step of, in a case where the predefined process has not been completed, querying the process performing apparatus about the progress status at the determined time interval.

According to the present embodiment, in the case where a client terminal uses a predefined function provided by a server apparatus, unnecessary communication traffic can be reduced and at the same time process loads of the client terminal and the server apparatus can be decreased.

### BRIEF DESCRIPTION OF THE DRAWINGS

Other objects and further features of embodiments will become apparent from the following detailed description when read in conjunction with the accompanying drawings.

FIG. 1 is a drawing illustrating an example of operations of a file management system according to a present embodiment.

FIG. 2 is a block diagram illustrating a hardware configuration of a client terminal according to the present embodiment.

FIG. 3 is a block diagram illustrating a functional configuration of a file management server and the client terminal according to the present embodiment.

FIG. 4 is a flowchart illustrating a process of the client terminal according to the present embodiment, a process in which the client terminal causes the file management server to perform a process corresponding to a process request.

FIG. 5 is a flowchart illustrating a process of the file management server, a process in which the file management server performs the process corresponding to the process request.

FIG. 6 is a drawing illustrating an example of a process-in-progress display according to the present embodiment.

FIG. 7 is a drawing illustrating an example of a process-completed display according to the present embodiment.

FIG. 8 is a drawing illustrating intervals of the polling for the file management server performed by the client terminal according to the present embodiment.

FIG. 9 is a flowchart illustrating a process of the client terminal according to the present embodiment, a process in which the client terminal causes the file management server to perform a process corresponding to a process request.

FIG. 10 is a flowchart illustrating a process of the client terminal according to the present embodiment, a process in which the client terminal causes the file management server to perform a process corresponding to a process request.

FIG. 11 is a flowchart illustrating a process of the client terminal according to the present embodiment, a process in which the client terminal causes the file management server to perform a process corresponding to a process request.

### DESCRIPTION OF THE PREFERRED EMBODIMENTS

In the following, embodiments of the present invention will be described with reference to the accompanying drawings. A file management system will be described as an example of the present invention, in which system, a client terminal as a process requesting apparatus which is implemented by an information processing apparatus such as a PC (Personal Computer), etc., is connected via a network to a file management server as a process performing apparatus which provides a function of storing/managing/sharing/distributing digitized information such as electronic documents, electronic images, etc., as files.

Note that the client terminal according to the present embodiment is configured to, in the above file management system, transmit a process request when the client terminal uses a function provided by the file management server and cause the file management server to perform the process corresponding to the process request. Also, the client terminal is configured to perform the “polling” in which the client terminal, after transmitting the process request, queries the file management server about a progress status of the requested process such as whether the process has been completed or not, to what extent the process has been performed, etc., at a defined interval. On the other hand, the file management server which receives the query is configured to report the progress status of the process as a response to the query to the client terminal which is a transmission source of the process request.

In this kind of the file management system, one of the objectives of the present embodiment is, in the case where the client terminal causes the file management server to perform the process corresponding to the process request, to cause the interval of the polling (hereinafter referred to as “polling interval”), at which the client terminal performs the polling of the file management server, to be longer as the elapsed time from the start of performing the process by the file management server becomes longer.

Specifically, in the case where a time interval from when the performing of the process has started to when the first polling is performed is defined as a₁, a time interval from when the first polling has been performed to when the second polling is performed is defined as a₂, a time interval from when the second polling has been performed to when the third polling is performed is defined as a₃, . . . , and a time interval from when the n−1^{tth} polling has been performed to when the n^{th} polling is performed is defined as aₙ, aₙ is determined to be aₙ>aₙ₋₁ (n is an integer, n>=1). Note that the 0^{th} polling corresponds to the start of the performing of the process.

Also, in the present embodiment, in the case where the elapsed time from the start of performing the process to the process completion by the file management server (hereinafter referred to as “time interval b”) is short, a time lag from when the process has been completed by the file management server to when the client terminal detects the process completion (hereinafter referred to as “time interval c”) is short. On the other hand, in the case where the time interval b is long, the time interval c becomes longer. Because the ratio of the time interval c to the time interval b becomes smaller as the time interval b becomes longer, it appears that the real time capabilities do not decrease.

Therefore, according to the present embodiment, it becomes possible to reduce unnecessary communication traffic and to reduce the process load of the file management server and the client terminal without decreasing the real time capabilities. The details will be described below referring to the accompanying drawings.

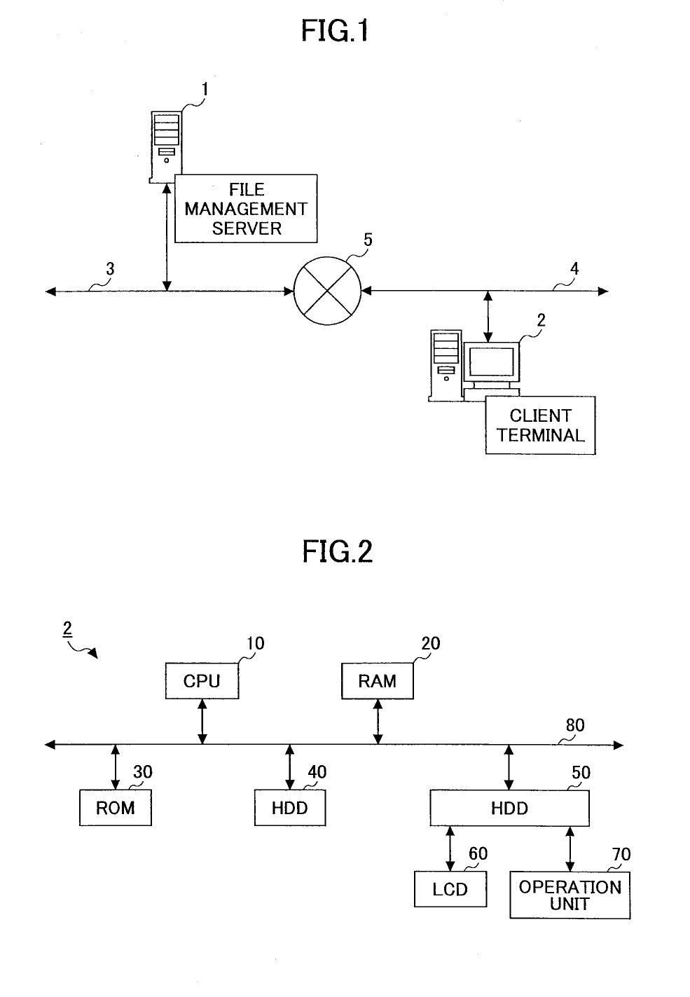

First, operations of the file management system according to the present embodiment will be described referring to FIG. 1. FIG. 1 is a drawing illustrating an example of operations of the file management system according to the present embodiment. As shown in FIG. 1, in the file management system, a network 3, to which the file management server 1 is connected, and a network 4, to which a client terminal 2 is connected, are connected through a public circuit 5 such as the Internet, a telephone circuit, etc.

Note that the number of the client terminal 2 connected to the network 4 is just an example, and the system may be a large scale system in which many more client terminals 2 are connected to the network 4. Also, multiple networks, to which different types of client terminals 2 are connected, may be connected to the file management server 1 through the public circuit 5, or the file management server 1 and the client terminal 2 may be connected to the same network.

The file management server 1 is a shared server for managing the file management system. In other words, the file management server 1 provides a function of storing/managing/sharing/distributing digitized information such as electronic documents, electronic images, etc., as files. Also, the file management server 1 manages users who are registered in the file management system, performs login authentication based on authentication information such as an ID, a password, etc., transmitted from the client terminal 2, and authorizes the use of the file management system according to the result of the login authentication.

The client terminal 2 is an information processing terminal operated by a user, and is implemented by an information processing apparatus such as a PC. The client terminal 2 may be implemented by a portable information terminal such as PDA (Personal Digital Assistant), a smart phone, a tablet terminal, etc. Note that in the client terminal 2, a file management application, which is specialized software for using the file management system, is installed.

The networks 3 and 4 are specific networks such as an office LAN (Local Area Network), and the file management server 1 and the client terminal 2 are connected to the public circuit 5 through each of the LANs. It is possible that the file management server 1 and the client terminal 2 are configured to be directly connected to the public circuit 5.

Next, hardware configurations of the file management server 1 and the client terminal 2 will be described referring to FIG. 2. FIG. 2 is a block diagram illustrating a hardware configuration of the client terminal 2 according to the present embodiment. In the following description, the hardware of the client terminal 2 is described as an example, and the hardware of the file management server 1 is about the same as the hardware of the client terminal 2.

As shown in FIG. 2, the client terminal 2 includes about the same configuration as an ordinary server or a PC. In other words, in the client terminal 2, a CPU (Central Processing Unit) 10, a RAM (Random Access Memory) 20, a ROM (Read Only Memory) 30, an HDD (Hard Disk Drive) 40 and an I/F 50 are connected via a bus 80. Also, an LCD (Liquid Crystal Display) 60 and an operation unit 70 are connected to the I/F 50.

The CPU 10 is a computing unit and controls overall operations of the client terminal 2. The RAM 20 is a volatile memory medium capable of fast reading and writing of information, and is used as a work area when the CPU 10 processes information. The ROM 30 is a read-only non-volatile memory medium in which programs such as firmware are stored. The HDD 40 is a non-volatile memory medium capable of fast reading and writing of information, in which an OS (Operating System), various kinds of control programs, application programs, etc., are stored.

The I/F 50 connects the bus 80 with various kinds of hardware and networks and controls them. The LCD 60 is a visual user interface for the user to check the state of the client terminal 2. The operation unit 70 is a user interface such as a keyboard, a mouse, a touch panel, etc., for the user to input information to the client terminal 2. Note that as described for FIG. 1, the file management server 1 is operated as a shared server. Therefore, the file management server 1 may not include user interfaces such as the LCD 60, the operation unit 70, etc.

In this kind of hardware configuration, a software control unit is configured by reading out programs stored in the memory medium such as the ROM 30, the HDD 40, or an optical disk which is not shown in the drawings into the RAM 20, and by causing the CPU 10 to compute according to the programs loaded into the RAM 20. Thus, the functional block which realizes the function of the client terminal 2 is configured by the combination of the software control unit, which is configured as described above, and the hardware.

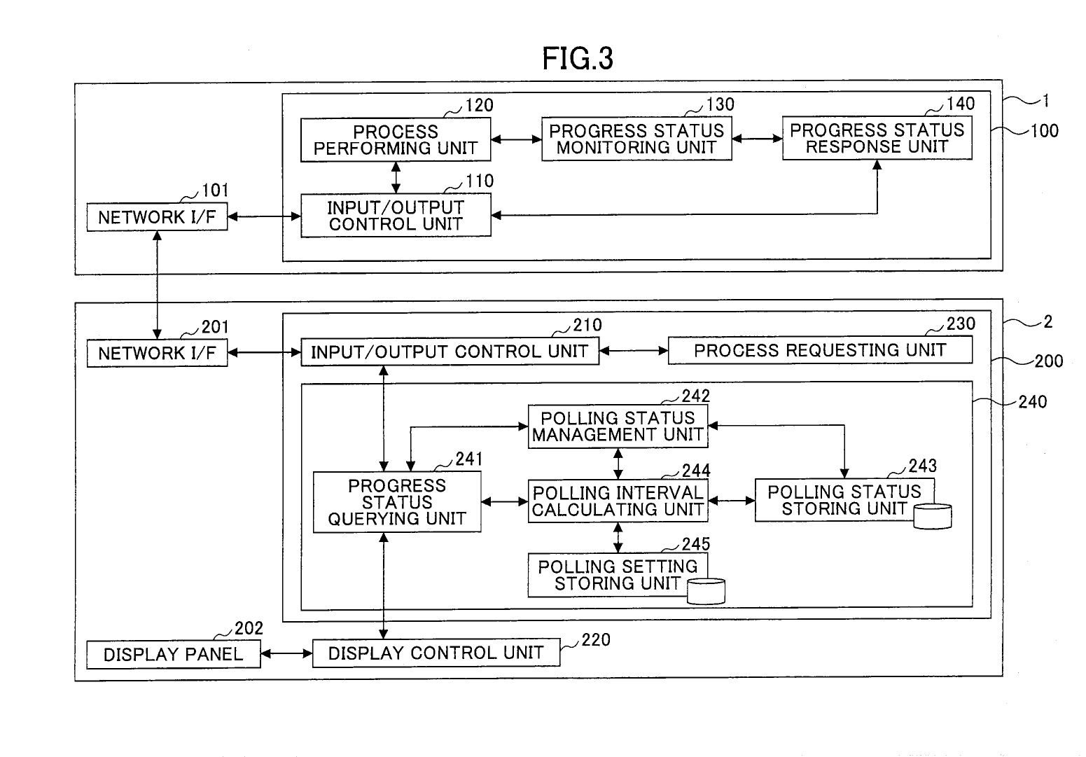

Next, the functional configurations of the file management server 1 and the client terminal 2 will be described referring to FIG. 3. FIG. 3 is a block diagram illustrating the functional configurations of the file management server 1 and the client terminal 2.

As shown in FIG. 3, the file management server 1 includes a controller 100 and a network I/F 101. The network I/F 101 is an interface for the file management server 1 to communicate with other devices such as the client terminal 2, for which an Ethernet (registered trademark) or USB interface is used. The network I/F 101 is implemented by the I/F 50 shown in FIG. 2.

The controller 100 is configured by a combination of software and hardware. Specifically, the controller 100 is configured by a software control unit and hardware such as an integrated circuit, the software control unit is configured by causing programs stored in the ROM 30, a non-volatile memory, a non-volatile memory medium such as the HDD 40, an optical disk, etc., to be loaded into the volatile memory such as the RAM 20, and by causing the CPU 10 to operate according to the programs. The controller 100 functions as a control unit which controls the file management server 1 as a whole.

Also, the controller 100 includes an input/output control unit 110, a process performing unit 120, a progress status monitoring unit 130 and a progress status response unit 140. The input/output control unit 110 inputs information, which is input through the network I/F 101, to each unit of the controller 100, or transmits information, which is output from each unit of the controller 100, to other devices such as the client terminal 2 through the network I/F 101.

The process performing unit 120 performs a process in accordance with a process request transmitted from the client terminal 2. Here, the process request is a request from the client terminal 2 for causing the file management server 1 to perform a predefined process. Also, the predefined processes performed by the process performing unit 120 are, for example, a process of creating in blocks the copies of the files in the folder stored in the file management server 1 in another folder, a process of deleting in blocks the files in the folder stored in the file management server 1, etc.

The progress status monitoring unit 130 monitors whether the process performed by the process performing unit 120 has been completed or not. The progress status response unit 140, in accordance with the monitoring result of the progress status monitoring unit 130, creates and outputs progress status reporting information which is used for reporting the progress status to the client terminal 2.

Also, as shown in FIG. 3, the client terminal 2 includes a controller 200, a network I/F 201 and a display panel 202. The network I/F 201 is an interface for the client terminal 2 to communicate with other devices such as the file management server 1 through a network, and Ethernet (registered trademark) or USB interface is used. The network I/F 201 is implemented by the I/F 50 shown in FIG. 2. The display panel 202 is an output interface for visually displaying the state of the client terminal 2. The display panel 202 is implemented by the LCD 60 shown in FIG. 2.

The controller 200 is configured by a combination of software and hardware. Specifically, the controller 200 is configured by a software control unit and hardware such as integrated circuit, the software control unit is configured by causing programs stored in the ROM 30, a non-volatile memory, a non-volatile memory medium such as the HDD 40, an optical disk, etc., to be loaded into the volatile memory such as the RAM 20, and by causing the CPU 10 to operate according to the programs. The controller 200 functions as a control unit which controls the client terminal 2 as a whole.

Also, the controller 200 includes an input/output control unit 210, a display control unit 220, a process requesting unit 230 and a polling control unit 240. The input/output control unit 210 inputs information, which is input through the network I/F 201, to each unit of the controller 200, or transmits information, which is output from each unit of the controller 200, to other devices such as the file management server 1 through the network I/F 201. The display control unit 220 displays information on the display panel 202. The process requesting unit 230 creates and outputs a process request for causing the file management server 1 to perform a predefined process.

The polling control unit 240 performs the control of the polling of the file management server 1 related to the process request, the polling which is performed by the client terminal 2. Also, the polling control unit 240 includes a progress status querying unit 241, a polling status management unit 242, a polling status storing unit 243, a polling interval calculating unit 244 and a polling setting storing unit 245.

The progress status querying unit 241 creates and outputs a progress status querying command to query about whether the process, which corresponds to the process request transmitted from the client terminal 2 to the file management server 1, has been completed or not. The polling status management unit 242 monitors the progress status querying unit 241 and updates the number of polling counts stored in the polling status storing unit 243 each time the polling of the process request is performed. The polling status storing unit 243 stores the number of polling counts of the process request. The polling status storing unit 243 is implemented by the RAM 20 or the HDD 40 shown in FIG. 2.

The polling interval calculating unit 244 calculates the polling interval of the client terminal 2 for the file management server 1 based on a setting for calculating the polling interval stored in the polling setting storing unit 245 and the number of polling counts stored in the polling status storing unit 243. Here, the setting for calculating the polling interval is a Formula (1), which will be described later, or constants (α, β, γ) included in the Formula (1). The polling setting storing unit 245 stores the setting for the polling interval calculating unit 244 to calculate the polling interval and other settings related to the polling. The polling setting storing unit 245 is implemented by the ROM 30 shown in FIG. 2.

In the file management system configured as above, one of the objectives of the present embodiment is, in the case where the client terminal 2 causes the file management server 1 to perform the process corresponding to the process request, to cause the polling interval, at which the client terminal 2 performs the polling of the file management server 1, to become longer as the elapsed time from the start of performing the process by the file management server 1 becomes longer.

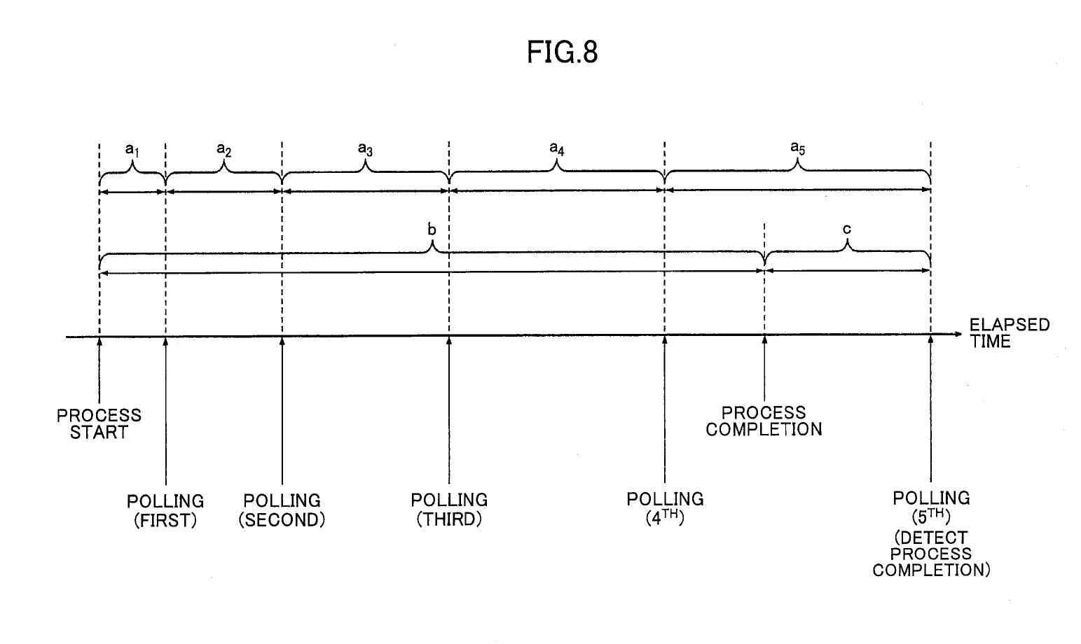

Specifically, in the case where a time interval from when the performing of the process starts to when the first polling is performed is defined as a₁, a time interval from when the first polling has been performed to when the second polling is performed is defined as a₂, a time interval from when the second polling has been performed to when the third polling is performed is defined as a₃, . . . , and a time interval from when the n−1^{th} polling has been performed to when the n^{th} polling is performed is defined as aₙ, aₙ is determined to be aₙ>aₙ₋₁ (n is integer, n>=1) as shown in FIG. 8. FIG. 8 is a drawing illustrating the intervals of the polling of the client terminal 2 for the file management server 1.

Also, in the present embodiment, in the case where the elapsed time from the start of performing the process to the process completion by the file management server 1 (“time interval b” shown in FIG. 8) is short, a time lag from when the process has been completed by the file management server 1 to when the client terminal 2 detects the process completion (“time interval c” shown in FIG. 8) is short. On the other hand, in the case where the time interval b is long, the time interval c becomes long. Because the ratio of the time interval c to the time interval b becomes smaller as the time interval b becomes longer, it appears that the real time capabilities do not decrease.

Therefore, according to the file management system of the present embodiment, it becomes possible to reduce unnecessary communication traffic and to reduce the process load of the file management server 1 and the client terminal 2 without decreasing the real time capabilities. The details will be described below referring to the accompanying drawings.

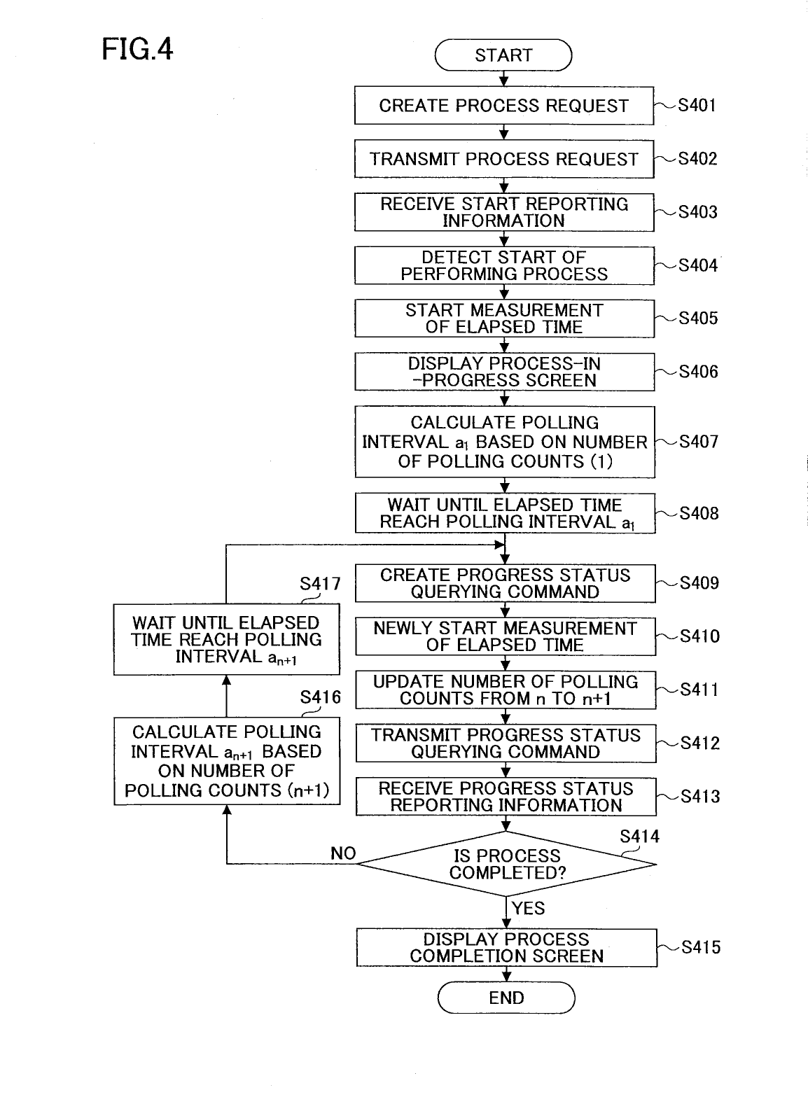

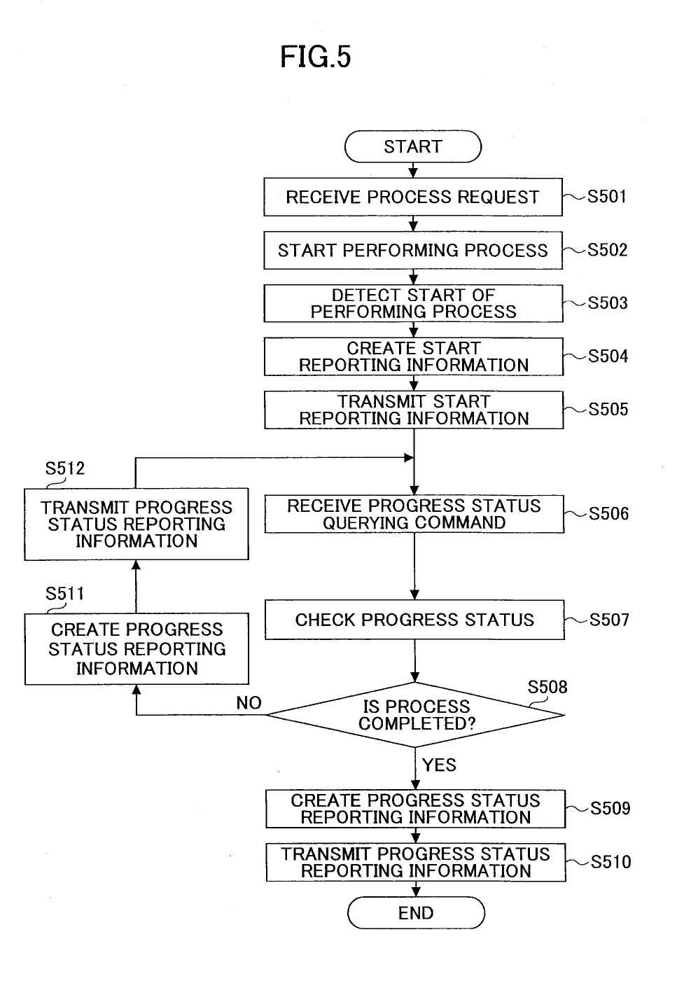

Next, a process of the client terminal 2 when it causes the file management server 1 to perform a predefined process will be described referring to FIG. 4 and FIG. 5. FIG. 4 is a flowchart illustrating a process when the client terminal 2 causes the file management server 1 to perform the process corresponding to the process request. FIG. 5 is a flowchart illustrating a process when the file management server 1 performs the process corresponding to the process request.

As shown in FIG. 4, when the client terminal 2 causes the file management server 1 to perform a process, the process requesting unit 230 creates a process request (S401), and transmits the created process request to the input/output control unit 210. The input/output control unit 210, when the process request is received from the process requesting unit 230, transmits the received process request to the file management server 1 through the network I/F 201 (S402). When the input/output control unit 210 transmits the process request to the file management server 1, the client terminal 2 waits until a start reporting information, which will be described later, is received from the file management server 1.

In the meantime, as shown in FIG. 5, in the case where the file management server 1 performs the process, when the process request is transmitted from the client terminal 2 to the file management server 1, the input/output control unit 110 receives the process request transmitted by the client terminal 2 through the network I/F 101 (S501), and transmits it to the process performing unit 120. The process performing unit 120, when the process request is received from the input/output control unit 110, starts performing the process corresponding to the received process request (S502).

The progress status monitoring unit 130 monitors the process performing unit 120 and, when it detects that the performing of the process has started (S503), reports the same to the progress status response unit 140. The progress status response unit 140, when it is reported by the progress status monitoring unit 130 that the performing of the process is started, creates start reporting information for reporting the same to the client terminal 2 (S504), and transmits the created start reporting information to the input/output control unit 110.

The input/output control unit 110, when it receives the start reporting information from the process performing unit 120, transmits the received start reporting information to the client terminal 2 through the network I/F 101 (S505). When the input/output control unit 110 transmits the start reporting information to the client terminal 2, the file management server 1, while performing the process, waits until it receives a progress status querying command from the client terminal 2.

When the start reporting information is transmitted from the file management server 1 to the client terminal 2, the input/output control unit 210 receives the start reporting information transmitted by the file management server 1 through the network I/F 201 (S403), and transmits the received start reporting information to the progress status querying unit 241. The progress status querying unit 241, when it receives the start reporting information from the input/output control unit 210, detects that the performing of the process corresponding to the process request is started by the file management server 1 (S404).

The progress status querying unit 241, when it detects that the performing of the process is started by the file management server 1, reports the same to the display control unit 220 and the polling interval calculating unit 244, while at the same time starting the measurement of the elapsed time from when it detects that the performing of the process is started by the file management server 1 (S405).

Note that, as described in the process of S404, the progress status querying unit 241 detects that the performing of the process is started by the file management server 1 based on the start reporting information received from the input/output control unit 210. The progress status querying unit 241 may detect that the performing of the process is started by the file management server 1 based on the fact that the process request is transmitted to the file management server 1.

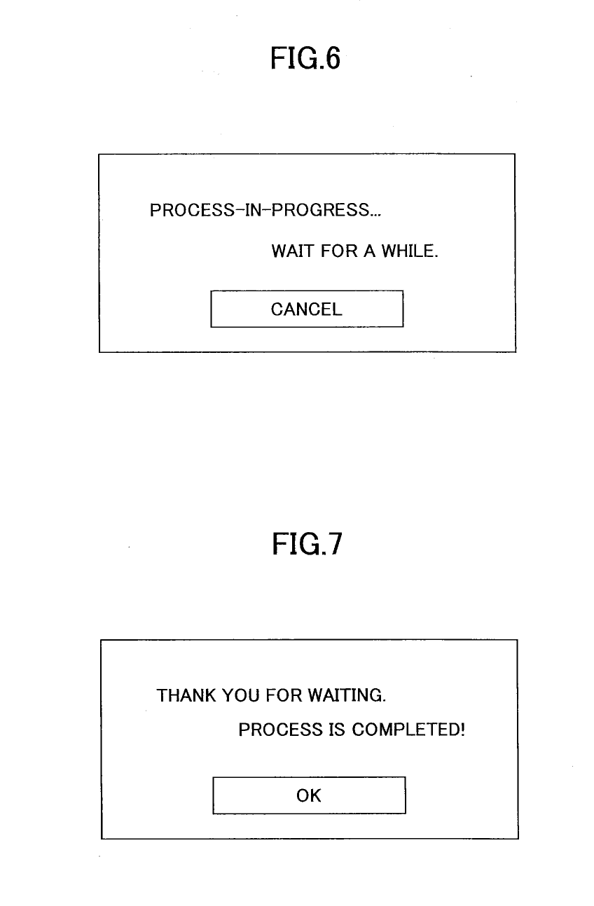

The display control unit 220, when the detection of the start of performing the process is reported by the progress status querying unit 241, displays on the display panel 202 a process-in-progress screen in order to report to the user that the process is being performed by the file management server 1 (S406). An example of the process-in-progress screen is shown in FIG. 6.

Also, the polling interval calculating unit 244, when the detection of the start of performing the process is reported by the progress status querying unit 241, based on the number of polling counts n stored in the polling status storing unit 243, calculates the time from the detection of the start of performing the process by the progress status querying unit 241 to the first polling is performed, which is the polling interval a₁, according to the Formula (1) below stored in the polling setting storing unit 245 (S407). In other words, the polling interval calculating unit 244 functions as a time interval determining unit. Note that, in the polling status storing unit 243 in the process of S407, n=1 is stored as an initial value of the number of polling count. Also, in the Formula (1) below, α, β and γ are predefined constants and are real numbers greater than zero.

[Formula 1]

aₙ=α(n−1)^{γ}+β (1)

Here, the Formula (1) will be described. The Formula (1) means that the time from when the n−1^{th} polling has been performed to when the n^{th} polling is performed, which is the polling interval aₙ, is determined in accordance with the-number-of-times-polling-performed-so-far to the γ^{th} power. In other word, in the file management system according to the present embodiment, in the case where the client terminal 2 causes the file management server 1 to perform the process corresponding to the process request, it becomes possible to cause the polling interval, at which the client terminal 2 performs the polling of the file management server 1, to become longer as the elapsed time from the start of performing the process by the file management server 1 becomes longer. Therefore, it becomes possible to reduce unnecessary communication traffic and at the same time to reduce the process load of the file management server 1 and the client terminal 2.

According to the Formula (1), in the process of S407 where the number of polling counts so far is zero, in other words, the number of polling counts stored in the polling status storing unit 243 is n=1, the polling interval a₁ is calculated as β.

Note that β is described as a predefined constant. But β may be set by the polling interval calculating unit 244 in accordance with the content of the process that the file management server 1 is caused to perform.

The reason is that as it is shown in the Formula (1), β is the same as the minimum polling interval a₁. So, for example, in the case where the process performed by the file management server 1 is expected to be completed at once because the number of steps of the process performed by the file management server 1 is small, by setting the value of β small, it becomes possible to cause the time lag, which is the time from when the process has been completed by the file management server 1 to when the client terminal 2 detects the completion, to be small.

By having the configuration like this, it becomes possible to cause the time lag, which is the time from when the process has been completed by the file management server 1 to when the client terminal 2 detects the completion, to be small even for whatever kind of process the client terminal 2 causes the file management server 1 to perform. Note that as an example of a process with a small number of steps to be performed by the file management server 1, there is a process of creating in blocks the copies of the files in the folder stored in the file management server 1 in another folder, in which the data size of the copies is small.

Also, in the case where the file management system is configured in such a way that the communication is automatically disconnected because of the timeout when there is no transmission and reception of information between the client terminal 2 and the file management server 1 for more than a certain amount of time, it is only necessary that the maximum value of the polling interval is configured to be set less than the timeout value.

The progress status querying unit 241, when the polling interval a₁ is calculated by the polling interval calculating unit 244, waits until the elapsed time, whose measurement has started in the process of S405, reaches the calculated polling interval a₁ (S408). The progress status querying unit 241, when the elapsed time, whose measurement has started in the process of S405, reaches the polling interval a₁ calculated in the process of S407, creates a progress status querying command to query the file management server 1 about the progress status (S409), transmits the command to the input/output control unit 210 and at the same time resets the elapsed time measurement, which has started in the process of S405, and newly starts the measurement of the elapsed time (S410). In other words, the progress status querying unit 241 functions as a progress status querying unit.

Also, the polling status management unit 242 monitors the progress status querying unit 241, and updates the polling count number, which is stored in the polling status storing unit 243, from n to n+1 when the progress status querying command is transmitted to the input/output control unit 210 and the measurement of the elapsed time is newly started (S411). Note that because the polling count number stored in the polling status storing unit 243 in the process of S407 is n=1, the polling count number stored in the polling status storing unit 243 is supposed to be updated from 1 to 2 in the process of S411.

In the meantime, the input/output control unit 210, when the progress status querying command is received from the progress status querying unit 241, transmits the received progress status querying command to the file management server 1 through the network I/F 201 (S412). After the input/output control unit 210 transmits the progress status querying command to the file management server 1, the client terminal 2 waits until it receives a progress status reporting information from the file management server 1.

When the progress status querying command is transmitted from the client terminal 2 to the file management server 1, the input/output control unit 110 receives the progress status querying command transmitted by the client terminal 2 through the network I/F 101 (S506) and transmits the received progress status querying command to the progress status response unit 140. The progress status response unit 140, when the progress status querying command is received from the input/output control unit 110, queries the progress status monitoring unit 130 about the progress status.

The progress status monitoring unit 130, when the progress status is queried by the progress status response unit 140, monitors the process performing unit 120, checks the progress status whether the process has been completed or not (S507), and reports the progress status to the progress status response unit 140. The progress status response unit 140, when the progress status is reported by the progress status monitoring unit 130, determines whether the process has been completed (S508). The progress status response unit 140, when it determines that the process has been completed (S508/YES) in the determination process of S508, creates progress status reporting information for reporting the progress status indicating whether the process has been completed or not to the client terminal 2 (S509), and transmits it to the input/output control unit 110.

Note that, as described in S507 through S509, in the present embodiment, the progress status monitoring unit 130 checks the progress status whether the process by the process performing unit 120 has been completed or not, and the progress status response unit 140 creates the progress status reporting information indicating whether the process has been completed or not based on the progress status. The present embodiment may be configured in such a way that the progress status monitoring unit 130 checks the degree of the process progress by the process performing unit 120 as the progress status, and the progress status response unit 140 creates the progress status reporting information indicating the degree of the progress based on the progress status. By having the configuration like this, it becomes possible that the client terminal 2, is not only able to determine whether the process requested to the file management server 1 has been completed or not, but is also able to know the degree of the process progress.

The input/output control unit 110, when the progress status reporting information is received from the progress status response unit 140, transmits the received progress status reporting information to the client terminal 2 through the network I/F 201 (S510). In this way, the file management server 1 ends performing the process corresponding to the process request.

In the meantime, the progress status response unit 140, when it determines that the process has not been completed (S508/NO) in the determination process of S508, creates the progress status reporting information for reporting the progress status to the client terminal 2 (S511), and transmits it to the input/output control unit 110. Note that in the created progress status reporting information, included is information indicating that the process has not been completed. The input/output control unit 110, when the progress status reporting information is received from the progress status response unit 140, transmits the received progress status reporting information to the client terminal 2 through the network I/F 201 (S512).

After the input/output control unit 110 transmits the progress status reporting information to the client terminal 2, the file management server 1 waits until it receives the next progress status querying command from the client terminal 2 and performs the process corresponding to the process request by repeatedly performing the processes of S506 through S508, S511 and S512 until it is determined that the process has been completed in the determination process of S508.

When the progress status reporting information is transmitted from the file management server 1 to the client terminal 2, the input/output control unit 210 receives the progress status reporting information transmitted by the file management server 1 through the network I/F 201 (S413), and transmits the received progress status reporting information to the progress status querying unit 241. The progress status querying unit 241, when the progress status reporting information is received from the input/output control unit 210, determines whether the process at the file management server 1 has been completed based on the received progress status reporting information (S414). In other words, the progress status querying unit 241 functions as a progress status obtaining unit and a completion determining unit.

The progress status querying unit 241, in the case where it determines that the process at the file management server 1 has been completed in the determination process of S414 (S414/YES), reports the same to the display control unit 220. The display control unit 220, when it is reported by the progress status querying unit 241 that the process at the file management server 1 has been completed, displays on the display panel 202 the process completion screen notifying the user of the completion of the process at the file management server 1 (S415). A display example of the process completion screen is shown in FIG. 7. Then, the client terminal 2 ends the process of causing the file management server 1 to perform the process.

In the meantime, the progress status querying unit 241, in the case where it determines that the process at the file management server 1 has not been completed in the determination process of S414 (S414/NO), reports the same to the polling interval calculating unit 244. The polling interval calculating unit 244, when it is notified by the progress status querying unit 241 that the process at the file management server 1 is being performed, calculates the time from when the n^{th} polling has been performed to when the next polling is performed, which is the polling interval aₙ₊₁, based on the polling count number n+1 stored in the polling status storing unit 243, using the Formula (1) stored in the polling setting storing unit 245 (S416).

The progress status querying unit 241, when the polling interval aₙ₊₁ is calculated by the polling interval calculating unit 244, waits until the elapsed time, whose measurement has newly started in the process of S410, reaches the calculated polling interval aₙ₊₁ (S417). Then, when the elapsed time, whose measurement has newly started in the process of S410, reaches the polling interval aₙ₊₁ calculated in the process of S416, the progress status querying unit 241 performs the processes of S409 and thereafter. In this way, the client terminal 2, by repeatedly performing the processes of S409 through S417 until it is determined that the process at the file management server 1 has been completed in the determination process of S414, causes the file management server 1 to perform the process corresponding to the process request.

As described above, in the file management system according to the present embodiment, one of the objectives is, in the case where the client terminal 2 causes the file management server 1 to perform the process corresponding to the process request, to cause the polling interval, at which the client terminal 2 performs the polling of the file management server 1, to become longer as the elapsed time from the start of performing the process by the file management server 1 becomes longer. Specifically, as shown in FIG. 8, aₙ is determined so as to be aₙ>aₙ₋₁ (n is integer, n>=1).

In the present embodiment, in the case where the time interval b is short, the time interval c is short. On the other hand, in the case where the time interval b is long, the time interval c becomes longer. Because the ratio of the time interval c to the time interval b becomes smaller as the time interval b becomes longer, it appears that the real time capabilities do not decrease.

Therefore, according to the file management system of the present embodiment, it becomes possible to reduce unnecessary communication traffic and to reduce the process load of the file management server 1 and the client terminal 2 without decreasing the real time capabilities.

Note that, in the present embodiment, an example is described, in which example, as shown in the Formula (1), the time from when the n−1^{th} polling has been performed to when the n^{th} polling is performed, which is the polling interval aₙ, is determined in accordance with the-number-of-times-polling-performed-so-far (n−1) to the γ^{th} power. The present embodiment may be configured in such a way that the polling interval aₙ is determined in accordance with the elapsed time from when the performing the process at the file management server 1 is started to when the n−1^{th} polling is performed to the γ^{th} power. In other words, in the case of this kind of configuration, the polling interval aₙ is determined by the Formula (2) below. Note that in the Formula (2), α, β and γ are predefined constants and are real numbers greater than zero.

$$\begin{matrix}[ Formula 2 ] & \\ \begin{matrix}{a}_{n} = β & ( n = 1 ) \\ {a}_{n} = {α ( {\sum }_{k = 1}^{n - 1} {a}_{k} )}^{γ} + β & ( n \geq 2 )\end{matrix} & ( 2 )\end{matrix}$$

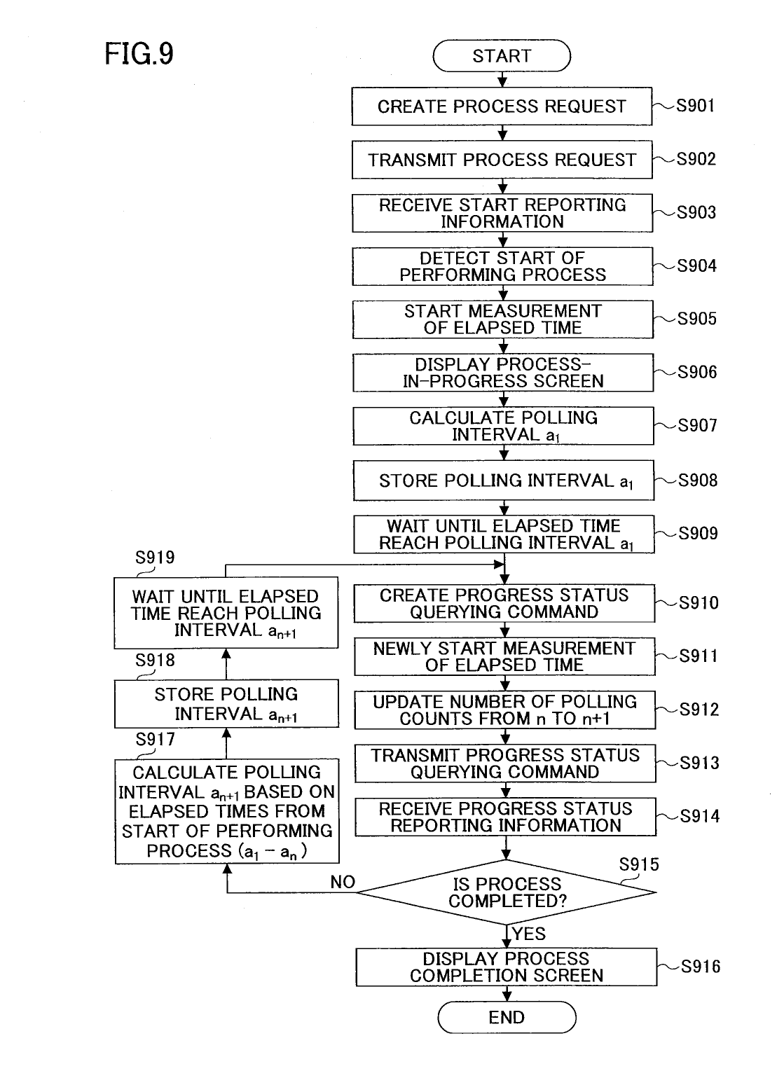

Here, in the case where the polling interval aₙ from when the n−1^{th} polling has been performed to when the n^{th} polling is performed is calculated by using the above Formula (2), the process of the client terminal 2 for causing the file management server 1 to perform the process will be described referring to FIG. 9. FIG. 9 is a flowchart illustrating the process for the client terminal 2 to cause the file management server 1 to perform the process corresponding to the process request.

AS shown in FIG. 9, in order for the client terminal 2 to cause the file management server 1 to perform the process, the client terminal 2 performs the processes about the same as the processes of S401 through S406 described referring to FIG. 4 (S901 through S906). Then, when the detection of the start of the performing of the process is reported by the progress status querying unit 241, the polling interval calculating unit 244 calculates the time from when the progress status querying unit 241 has detected the start of the performing of the process by the file management server 1 to when the first polling is performed, which is the polling interval a₁, using the above Formula (2) which is stored in the polling setting storing unit 245 (S907).

The polling status management unit 242, after the polling interval a₁ is calculated by the polling interval calculating unit 244, stores the calculated polling interval a₁ in the polling status storing unit 243 (S908). After the calculated polling interval a₁ is stored in the polling status storing unit 243, the client terminal 2 performs the processes about the same as the processes of S408 through S414 described referring to FIG. 4 (S909 through S915).

Then, in the case where the progress status querying unit 241 determines that the process at the file management server 1 has been completed in the determination process of S915 (S915/YES), the client terminal 2 performs the processes about the same as the processes of S415 described referring to FIG. 4 (S916), and ends the process of causing the file management server 1 to perform the process.

In the meantime, in the case where the progress status querying unit 241 determines that the process at the file management server 1 has not been completed in the determination process of S915 (S915/NO), the progress status querying unit 241 reports the same to the polling interval calculating unit 244. The polling interval calculating unit 244, when it is reported by the progress status querying unit 241 that the process at the file management server 1 is in progress, calculates the time from when the n^{th} polling has been performed to when the next polling is performed, which is the polling interval aₙ₊₁, based on the first polling interval a₁ through the n^{th} polling interval aₙ stored in the polling status storing unit 243, using the Formula (2) stored in the polling setting storing unit 245 (S917).

The polling status management unit 242, after the polling interval aₙ₊₁ is calculated by the polling interval calculating unit 244, stores the calculated polling interval aₙ₊₁ in the polling status storing unit 243 (S918). The progress status querying unit 241, after the polling interval aₙ₊₁ is calculated and stored in the polling status storing unit 243, waits until the elapsed time, whose measurement has newly started in the process of S911, reaches the calculated polling interval aₙ₊₁ (S919). Then, the progress status querying unit 241, when the elapsed time, whose measurement has newly started in the process of S911, reaches the polling interval aₙ₊₁ calculated in the process of S917, performs the processes about the same as the processes of S910 and thereafter.

In this way, the client terminal 2, by repeatedly performing the processes of S910 through S919 until it is determined that the process at the file management server 1 has been completed in the determination process of S914, causes the file management server 1 to perform the process corresponding to the process request.

Note that, in FIG. 9, the elapsed time Aₙ₋₁ from when the start of the performing of the process at the file management server 1 has been detected by the progress status querying unit 241 to when the n−1^{th} polling is performed is calculated by the Formula (3).

$$\begin{matrix}[ Formula 3 ] & \\ \begin{matrix}{A}_{n - 1} = {\sum }_{k = 1}^{n - 1} {a}_{k} & ( n \geq 2 )\end{matrix} & ( 3 )\end{matrix}$$

The elapsed time Aₙ₋₁ may be an actually measured time. In other words, the above elapsed time Aₙ₋₁ may be an actually measured elapsed time from when the measurement has started in the process of S905 to when the n−1^{th} polling is performed.

Also, in the case where the client terminal 2 is capable of detecting the degree of the process progress being performed at the file management server 1, the present embodiment may be configured in such a way that aₙ, which is the polling interval from when the n−1^{th} polling has been performed to when the n^{th} polling is performed, is determined in accordance with Bₙ₋₁ to the γ^{th} power, which Bₙ₋₁ is the degree of the process progress at the file management server 1 when the n−1^{th} polling has been performed. In other words, in the case of this kind of configuration, the polling interval aₙ is determined by the Formula (4) below. Note that in the Formula (4), α, β and γ are predefined constants and are real numbers greater than zero.

[Formula 4]

aₙ=β (n=1)

aₙ=α(Bₙ₋₁)^{γ}+β (n≧2) (4)

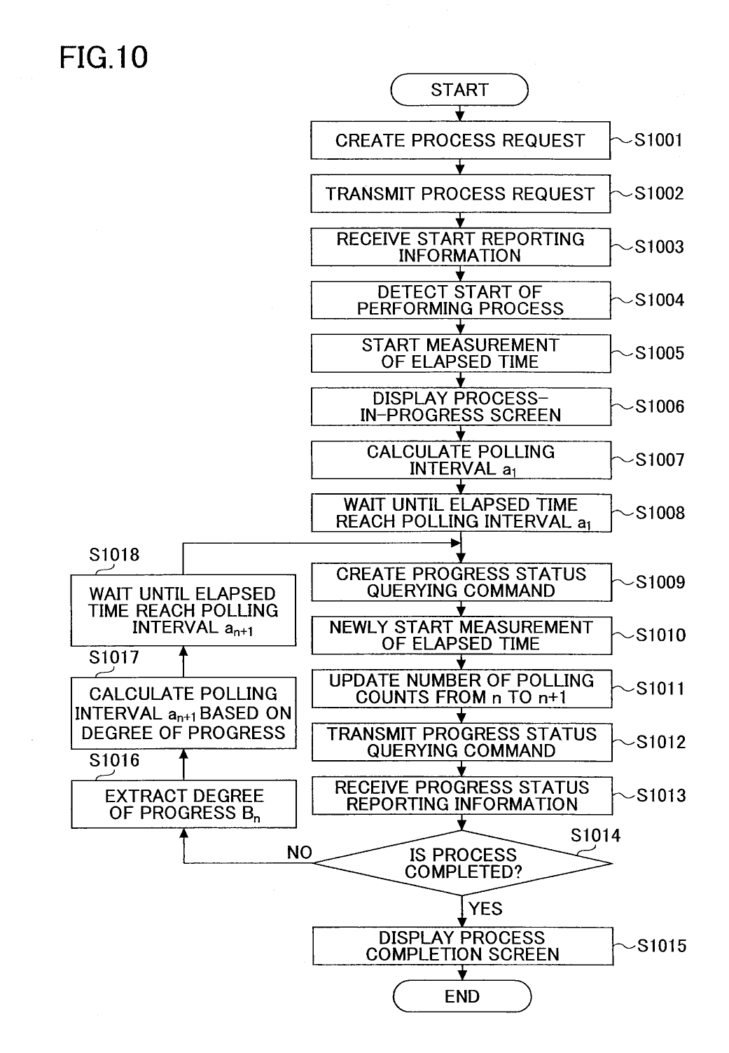

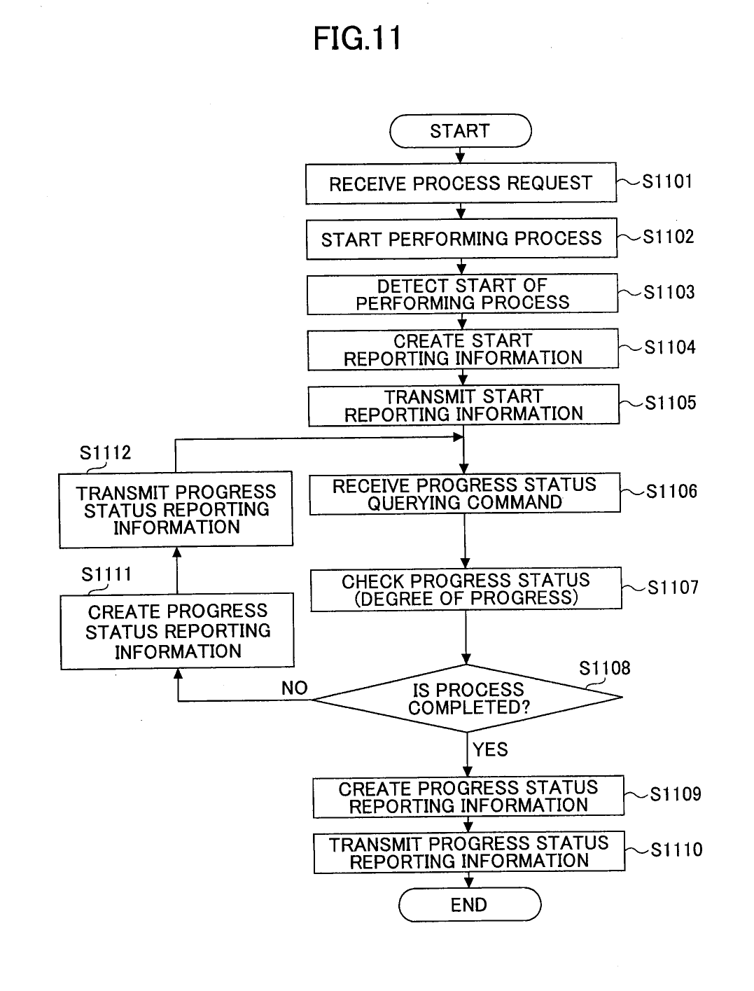

Here, in the case where the polling interval aₙ from when the n−1^{th} polling has been performed to when the n^{th} polling is performed is calculated by using the above Formula (4), the process of the client terminal 2 for causing the file management server 1 to perform the process will be described referring to FIG. 10 and FIG. 11. FIG. 10 is a flowchart illustrating the process for the client terminal 2 to cause the file management server 1 to perform the process corresponding to the process request. FIG. 11 is a flowchart illustrating the process for the file management server 1 to perform the process corresponding to the process request.

As shown in FIG. 10, when the client terminal 2 according to the present embodiment causes the file management server 1 to perform the process, the client terminal 2 performs the processes about the same as the processes of S401 and S402 described referring to FIG. 4 (S1001, S1002). After the input/output control unit 210 transmits the process request to the file management server 1, the client terminal 2 waits until the start reporting information, which will be described later, is received from the file management server 1.

In the meantime, as shown in FIG. 10, in the case where the file management server 1 according to the present embodiment performs the process, when the process request is transmitted from the client terminal 2 to the file management server 1, the file management server 1 performs the processes about the same as the processes of S501 through S505 described referring to FIG. 5 (S1101 through S1105). After the input/output control unit 110 transmits the start reporting information to the client terminal 2, the file management server 1, while performing the process, waits until the progress status querying command is received from the client terminal 2.

When the start reporting information is transmitted from the file management server 1 to the client terminal 2, the client terminal 2 performs the processes about the same as the processes of S403 through S406 described referring to FIG. 4 (S1003 through S1006). Then, the polling interval calculating unit 244, when it is reported by the progress status querying unit 241 that the start of the performing of the process is detected, calculates the time from when the progress status querying unit 241 has detected the start of the performing of the process at the file management server 1 to when the first polling is performed, which is the polling interval a₁, by using the above Formula (4) stored in the polling setting storing unit 245 (S1007).

When the polling interval a₁ is calculated, the client terminal 2 performs the processes about the same as the processes of S408 through S412 described referring to FIG. 4 (S1008 through S1012). When the input/output control unit 210 transmits the progress status querying command to the file management server 1, the client terminal 2 waits until the progress status reporting information is received from the file management server 1.

When the progress status querying command is transmitted from the client terminal 2 to the file management server 1, the input/output control unit 110 receives the progress status querying command transmitted by the client terminal 2 through the network I/F 101 (S1106), transmits the received progress status querying command to the progress status response unit 140. The progress status response unit 140, when the progress status querying command is received from the input/output control unit 110, query the progress status monitoring unit 130 about the progress status.

The progress status monitoring unit 130, when the progress status is queried by the progress status response unit 140, monitors the process performing unit 120, checks the degree of the process progress Bₙ as the progress status (S1107), and reports it to the progress status response unit 140. The progress status response unit 140, when the progress status is reported by the progress status monitoring unit 130, determines whether the process has been completed based on the degree of the progress (S1108). The progress status response unit 140, in the case where it is determined that the process is completed in the determination process of S1108 (S1108/YES), creates the progress status reporting information for reporting the degree of the progress to the client terminal 2 (S1109), and transmits it to the input/output control unit 110.

The input/output control unit 110, when the progress status reporting information is received from the progress status response unit 140, transmits the received progress status reporting information to the client terminal 2 through the network I/F 201 (S1110). In this way, the file management server 1 ends the performing of the process corresponding to the process request.

In the meantime, the progress status response unit 140, in the case where it is determined that the process has not been completed in the determination process of S1108 (S1108/NO), creates the progress status reporting information for reporting the degree of the progress to the client terminal 2 (S1111), and transmits it to the input/output control unit 110. The input/output control unit 110, when the progress status reporting information is received from the progress status response unit 140, transmits the received progress status reporting information to the client terminal 2 through the network I/F 201 (S1112).

When the input/output control unit 110 transmits the progress status reporting information to the client terminal 2, the file management server 1 waits until the next progress status querying command is received from the client terminal 2, and performs the process corresponding to the process request by repeatedly performing the processes of S1106 through S1108, S1111 and S1112 until it is determined that the process has been completed in the determination process of S1108.

When the progress status reporting information is transmitted from the file management server 1 to the client terminal 2, the client terminal 2 performs the processes about the same as the processes of S413 and S414 described referring to FIG. 4 (S1013, S1014).

In the case where the progress status querying unit 241 determines that the process at the file management server 1 has been completed in the determination process of S1014 (S1014/YES), the client terminal 2 performs the process about the same as the process of S415 described referring to FIG. 4 (S1015), and ends the process of causing the file management server 1 to perform the process.

In the meantime, in the case where the progress status querying unit 241 determines that the process at the file management server 1 has not been completed in the determination process of S1014 (S1014/NO), the progress status querying unit 241 analyses the received progress status reporting information, extracts the degree of process progress Bₙ at the file management server 1 (S1016), and reports it to the polling interval calculating unit 244. The polling interval calculating unit 244, when the degree of process progress Bₙ is reported by the progress status querying unit 241, calculates the time from when the n^{th} polling has been performed to when the next polling is performed, which is the polling interval aₙ₊₁, based on the reported degree of process progress Bₙ using the Formula (4) stored in the polling setting storing unit 245 (S1017).

The progress status querying unit 241, when the polling interval aₙ₊₁ is calculated, waits until the elapsed time, whose measurement has newly started in the process of S1010, reaches the calculated polling interval aₙ₊₁. Then, the progress status querying unit 241, when the elapsed time, whose measurement has newly started in the process of S1010, reaches the polling interval aₙ₊₁ calculated in the process of S1017, performs processes about the same as the processes of S1009 and thereafter.

In this way, the client terminal 2, by repeatedly performing the processes of S1010 through S1018 until it is determined that the process at the file management server 1 has been completed in the determination process of S1014, causes the file management server 1 to perform the process corresponding to the process request.

Also, in the above description, examples are described in which the polling interval aₙ from when the n−1^{th} polling has been performed to when the n^{th} polling is performed is determined based on, as shown in Formula (1), the-number-of-times-polling-performed-so-far (n−1) to the γ^{th} order; or, as shown in Formula (2), the elapsed time from the start of performing the process at the file management server 1 to when the n−1^{th} polling is performed to the γ^{th} power; or, as shown in Formula (4), Bₙ₋₁ to the γ^{th} power, which Bₙ₋₁ is the degree of the process progress at the file management server 1 when the n−1^{th} polling is performed. It is only required that aₙ be determined so as to be aₙ>aₙ₋₁.

In other words, aₙ may be calculated by applying any operation to the-number-of-times-polling-performed-so-far (n−1), to the elapsed time from the start of performing the process at the file management server 1 to when the n−1^{th} polling is performed, or to Bₙ₋₁, which is the degree of the process progress at the file management server 1 when the n−1^{th} polling is performed.

For example, the polling interval aₙ is determined by using any one of the following Formulas (5) through (7). Note that in the Formulas (5) through (7), α, β and γ are predefined constants and are real numbers greater than zero.

$$\begin{matrix}[ Formula 5 ] & \\ \begin{matrix}{a}_{n} = β & ( n = 1 ) \\ {a}_{n} = {αLog ( n - 1 )}^{γ} + β & ( n \geq 2 )\end{matrix} & ( 5 ) \\ [ Formula 6 ] & \\ \begin{matrix}{a}_{n} = β & ( n = 1 ) \\ {a}_{n} = {αLog ( {\sum }_{k = 1}^{n - 1} {a}_{k} )}^{γ} + β & ( n \geq 2 )\end{matrix} & ( 6 ) \\ [ Formula 7 ] & \\ \begin{matrix}{a}_{n} = β & ( n = 1 ) \\ {a}_{n} = {αLog ( {B}_{n - 1} )}^{γ} + β & ( n \geq 2 )\end{matrix} & ( 7 )\end{matrix}$$

Also, the polling interval aₙ is determined by using any one of the following Formulas (8) through (10). Note that in the Formulas (8) through (10), α, β and γ are predefined constants and are real numbers greater than zero.

$$\begin{matrix}[ Formula 8 ] & \\ \begin{matrix}{a}_{n} = β & ( n = 1 ) \\ {a}_{n} = {α ( γ + 1 )}^{n - 1} + β & ( n \geq 2 )\end{matrix} & ( 8 ) \\ [ Formula 9 ] & \\ \begin{matrix}{a}_{n} = β & ( n = 1 ) \\ {a}_{n} = {α ( γ + 1 )}^{( {\sum }_{k = 1}^{n - 1} {a}_{k} )} + β & ( n \geq 2 )\end{matrix} & ( 9 ) \\ [ Formula 10 ] & \\ \begin{matrix}{a}_{n} = β & ( n = 1 ) \\ {a}_{n} = {α ( γ + 1 )}^{{B}_{n - 1}} + β & ( n \geq 2 )\end{matrix} & ( 10 )\end{matrix}$$

As shown above, as long as the polling interval aₙ is determined so as to be aₙ>aₙ₋₁, any operation may be applied to the-number-of-times-polling-performed-so-far (n−1), to the elapsed time from the start of performing the process at the file management server 1 to when the n−1^{th} polling is performed, or to Bₙ₋₁, which is the degree of the process progress at the file management server 1 when the n−1^{th} polling is performed.

Also, in the present embodiments, the function, which is provided by the file management server 1 as a process performing apparatus, is described as the file management system used by the client terminal 2 as a process requesting apparatus. The present invention is not limited to these embodiments, but can be applied to any system, in which a client terminal uses a predefined function provided by a server apparatus, such as a video conference system which enables remote users to participate in a real time video conferencing, a book search system in which a user can search books stored in a library for a particular book, etc.

Further, the present invention is not limited to these embodiments, and various variations and modifications may be made without departing from the scope of the present invention.

The present invention can be implemented in any convenient form, for example using dedicated hardware, or a mixture of dedicated hardware and software. The present invention may be implemented as computer software implemented by one or more networked processing apparatuses. The network can comprise any conventional terrestrial or wireless communications network, such as the Internet. The processing apparatuses can compromise any suitably programmed apparatuses such as a general purpose computer, personal digital assistant, mobile telephone (such as a WAP or 3G-compliant phone) and so on. Since the present invention can be implemented as software, each and every aspect of the present invention thus encompasses computer software implementable on a programmable device. The computer software can be provided to the programmable device using any storage medium for storing processor readable code such as a floppy disk, hard disk, CD-ROM, magnetic tape device or solid state memory device. The hardware platform includes any desired kind of hardware resources including, for example, a central processing unit (CPU), a random access memory (RAM), and a hard disk drive (HDD). The CPU may be implemented by any desired kind of any desired number of processors. The RAM may be implemented by any desired kind of volatile or non-volatile memory. The HDD may be implemented by any desired kind of non-volatile memory capable of storing a large amount of data. The hardware resources may additionally include an input device, an output device, or a network device, depending on the type of the apparatus. Alternatively, the HDD may be provided outside of the apparatus as long as the HDD is accessible. In this example, the CPU, such as a cache memory of the CPU, and the RAM may function as a physical memory of a primary memory of the apparatus, while the HDD may function as a secondary memory of the apparatus.

The present application is based on and claims the benefit of priority of Japanese Priority Application No. 2012-270571 filed on Dec. 11, 2012, with the Japanese Patent Office, the entire contents of which are hereby incorporated by reference.

What is claimed is:

1. A process requesting apparatus for requesting a process performing apparatus to perform a predefined process and querying a progress status of the predefined process, the process requesting apparatus comprising:
a progress status obtaining unit configured to obtain, as a response to the query about the progress status to the process performing apparatus, the progress status from the process performing apparatus;
a completion determining unit configured to determine whether the predefined process has been completed or not based on the obtained progress status;
a time interval determining unit configured to determine a time interval from the last time the process requesting apparatus queried the progress status to the next time the process requesting apparatus queries the progress status according to an elapsed time from the start of the predefined process; and
a progress status querying unit configured to, in the case where the predefined process has not been completed, query the process performing apparatus about the progress status at the determined time interval.

2. The process requesting apparatus as claimed in claim 1, wherein the time interval determining unit determines the time interval in such a way that the time interval becomes longer as the elapsed time becomes longer.

3. The process requesting apparatus as claimed in claim 1, wherein the time interval determining unit determines the time interval by applying a predefined operation to the elapsed time in such a way that the time interval becomes longer as the elapsed time becomes longer.

4. The process requesting apparatus as claimed in claim 1, wherein the time interval determining unit determines the time interval according to the elapsed time multiplied by a real number greater than zero.

5. The process requesting apparatus as claimed in claim 1, wherein the time interval determining unit determines the time interval in such a way that the time interval becomes longer as the number of times the process requesting apparatus has queried the process performing apparatus about the progress status becomes greater.

6. The process requesting apparatus as claimed in claim 1, wherein the time interval determining unit determines the time interval by applying a predefined operation to a number of times the process requesting apparatus has queried the process performing apparatus about the progress status in such a way that the time interval becomes longer as the number of times the process requesting apparatus has queried the process performing apparatus about the progress status becomes greater.

7. The process requesting apparatus as claimed in claim 1, wherein the time interval determining unit determines the time interval according to the number of times the process requesting apparatus has queried the process performing apparatus about the progress status multiplied by a real number greater than zero.

8. The process requesting apparatus as claimed in claim 1, wherein the progress status obtaining unit obtains a degree of progress of the predefined process as the progress status, and the time interval determining unit determines the time interval according to the obtained degree of progress of the process.

9. The process requesting apparatus as claimed in claim 1, wherein the time interval determining unit determines the time interval from when the predefined process has been started by the process performing apparatus to when the first time the process requesting apparatus queries the process performing apparatus about the progress status according to the content of the predefined process.

10. A method of controlling a process requesting apparatus for requesting a process performing apparatus to perform a predefined process and querying a progress status of the predefined process, the method comprising:
a step of obtaining, as a response to the query about the progress status to the process performing apparatus, the progress status from the process performing apparatus;
a step of determining whether the predefined process has been completed or not based on the obtained progress status;
a step of determining a time interval from the last time the process requesting apparatus queried the progress status to the next time the process requesting apparatus queries the progress status according to an elapsed time from the start of the predefined process; and
a step of, in the case where the predefined process has not been completed, querying the process performing apparatus about the progress status at the determined time interval.

11. A computer-readable recording medium having a program embodied therein for causing a process requesting apparatus for requesting a process performing apparatus to perform a predefined process and querying a progress status of the predefined process to execute:
a step of obtaining, as a response to the query about the progress status to the process performing apparatus, the progress status from the process performing apparatus;
a step of determining whether the predefined process has been completed or not based on the obtained progress status;
a step of determining a time interval from the last time the process requesting apparatus queried the progress status to the next time the process requesting apparatus queries the progress status according to an elapsed time from the start of the predefined process; and
a step of, in the case where the predefined process has not been completed, querying the process performing apparatus about the progress status at the determined time interval.
